(19) United States
(12) Patent Application Publication
(10) Pub. No.: US 2019/0135671 A1
(43) Pub. Date: May 9, 2019

(54) Systems and Methods for Multi-Stage Fluid Separation

(71) Applicant: Cerahelix, Inc., Orono, ME (US)

(72) Inventors: James V. Banks, Orono, ME (US); Tracy Bantegui, Orono, ME (US)

(21) Appl. No.: 16/169,859

(22) Filed: Oct. 24, 2018

Related U.S. Application Data
(60) Provisional application No. 62/576,561, filed on Oct. 24, 2017.

(51) Int. Cl. C02F 9/00

(52) U.S. Cl. CPC C02F 9/00; C02F 1/463

(57) ABSTRACT

In some embodiments, a fluid separation system is provided. The system includes a reactor for coagulating one or more suspended fluids in a fluid solution. The system also includes a first filtration unit downstream of the reactor for removing a first portion of the coagulated solids. The system also includes a second filtration unit downstream of the first filtration unit for removing a second portion of the solids.

### CROSS REFERENCE TO RELATED APPLICATION(S)

This application is a divisional patent application of U.S. Patent Application No. 62/576,561, filed on Oct. 24, 2017, the entirety of which is hereby incorporated herein for all purposes.

### FIELD OF THE INVENTION

The present disclosure relates generally to fluid separation, and more particularly, to multi-stage fluid separation systems.

### BACKGROUND

Cross-flow filtration can be used in water treatment to enable molecular separations by passing a continuous feed solution across a surface of a filter medium. In water treatment as well as some molecular separation applications, a feed solution is delivered through an inlet at a flow rate and a pressure greater than the osmotic pressure of the feed solution, such that a portion of the feed solution is driven across the filter medium tangentially while a second portion of the feed solution passes through the filter medium.

### SUMMARY

In some embodiments of the present invention, a fluid separation system is provided. The system includes a reactor for coagulating one or more suspended materials in a fluid solution. The system also includes a first filtration unit downstream of the reactor for removing a first portion of the coagulated materials. The system also includes a second filtration unit downstream of the first filtration unit for receiving the flow from the first filtration unit and removing a second portion of the coagulated materials or an uncoagulated portion of the suspended materials.

In some embodiments, the reactor can provide electrochemical fluid separation functionality for separating the fluid solution and the filtration unit and second filtration unit provide filtration functionality for further separating the fluid solution.

In some embodiments of the present invention, a fluid separation system is provided. They system includes a pressurized feed pump for introducing a fluid solution at a first predetermined pressure, a recirculating pump for recirculating the fluid solution from the high-pressure feed pump downstream at a second predetermined pressure, and a filtering unit downstream of the recirculating pump for receiving the fluid solution at the second predetermined pressure, the filtering unit having a membrane provided with an array of pores approximately a diameter of a DNA strand to remove at least a portion of dissolved solids in the fluid solution passing across the membrane.

The filtering unit can include the membrane in one or more channels, each of which includes the membrane having the array of pores approximately the diameter of the DNA strand. The second predetermined pressure can provide a high cross flow velocity and high transmembrane pressures across the membrane of the filtering unit that optimizes gel formation and rejection of dissolved solids.

In some embodiments of the present invention, method for fluid separation is provided. The method includes introducing a fluid solution at a first predetermined pressure, by a pressurized feed pump, to a recirculating pump, recirculating the fluid solution at a second predetermined pressure, by the recirculating pump, to a filtering unit having a membrane provided with an array of pores approximately a diameter of a DNA strand, directing the fluid solution through the filtration unit parallel to the membrane at the second predetermined pressure to create a cross-flow filtration process to remove at least a portion of dissolved solids in the fluid solution, and outputting filtrate for disposal and a retentate for further use. The method can further include recirculating the retentate to the recirculating pump for repeated filtering.

In some embodiments of the present invention, fluid separation system is provided. The system includes a reactor for coagulating one or more suspended materials in a fluid solution, a first filtration unit downstream of the reactor for removing a first portion of the coagulated materials, and a second filtration unit downstream of the filtration unit for removing at least one of a second portion of the coagulated materials or an uncoagulated portion of the suspended materials.

In accordance with aspects of the present invention, the fluid includes one or more dissolved gasses, wherein the reactor at least partially de-gasses the solution. The reactor can further include an electrocoagulation unit capable of applying a direct current to the fluid solution. The first filtration unit can include a high efficiency/high solids capacity media filter (HECF). The second filtration unit can include a ceramic membrane filter. The system can further include a de-gassing chamber downstream of the reactor and upstream of the first filtration unit for permitting the gasses released from the de-gassed fluid solution to separate from the fluid solution and for permitting further coagulation of the suspended fluids. The system can further include a de-foaming unit for removing one or more of a volatile compound, a non-volatile compound, a fat, a grease, or an ammonia from the de-gassed fluid solution.

In accordance with aspects of the present invention, the system further includes an electro-desalinization device downstream of the second filtration unit for removing one or more of a divalent cation, a divalent anion, or a mono-valent salt from the fluid solution. The system can further include a second reactor upstream of the reactor for at least partially degassing the solution. The second reactor can be an electrocoagulation unit having a permanent electrode and the reactor can be an electrocoagulation unit having a sacrificial electrode to promote coagulation. The system can further include a second reactor downstream of the second filtration unit for coagulating one or more additional suspended materials in the fluid solution.

In some embodiments of the present invention, method for fluid separation is provided. The system includes coagulating, by a reactor, one or more suspended materials in a fluid solution, flowing the fluid solution through a first filtration unit downstream of the reactor to remove a first portion of the coagulated materials, and directing the fluid solution through or across a second filtration unit downstream of the first filtration unit to remove at least one of a second portion of the coagulated materials or an uncoagulated portion of the suspended materials.

In accordance with aspects of the present invention, the method can further include at least partially de-gassing, by the reactor, the fluid solution. The reactor can include an electrocoagulation unit, the step of coagulating further comprising applying a direct current to the fluid solution. The method can further include separating, in a degassing chamber downstream of the reactor, the gasses released from the de-gassed fluid solution and further coagulating, in the degassing chamber, the suspended fluids. The method can further include removing, by a de-foaming unit downstream of the degassing chamber, one or more of a volatile compound, a non-volatile compound, a fat, a grease, or an ammonia from the de-gassed fluid solution. The method can further include removing, by an electro-desalinization device downstream of the second filtration unit, one or more of a divalent cation, a divalent anion, or a mono-valent salt from the fluid solution. The method can further include at least partially degassing the solution using a second reactor upstream of the reactor. The method can further include coagulating, by a second reactor downstream of the second filtration unit, one or more additional suspended materials in the fluid solution.

In some embodiments of the present invention, fluid separation system is provided. The system includes a first reactor for at least partially degassing a fluid solution including one or more dissolved gasses, a second reactor for coagulating one or more suspended materials in the fluid solution, a first filtration unit downstream of the reactor for removing a first portion of the coagulated materials, and a second filtration unit downstream of the first filtration unit for removing at least one of a second portion of the coagulated materials or an uncoagulated portion of the suspended materials.

### BRIEF DESCRIPTION OF THE DRAWINGS

Illustrative, non-limiting example embodiments will be more clearly understood from the following detailed description taken in conjunction with the accompanying drawings.

FIG. 1 is a schematic diagram illustrating a multi-stage fluid separation system in accordance with various embodiments.

FIG. 2 is a schematic diagram illustrating another multi-stage fluid separation system in accordance with various embodiments.

FIG. 3 is a schematic diagram illustrating still another multi-stage fluid separation system in accordance with various embodiments.

FIG. 4 is a schematic diagram illustrating still another multi-stage fluid separation system in accordance with various embodiments.

FIG. 5 is a chart showing the advantages of the fluid separation system in accordance with various embodiments.

FIG. 6 is a chart showing the advantages of the fluid separation system in accordance with various embodiments.

FIG. 7 is a chart showing example study results for the fluid separation system in accordance with various embodiments.

FIG. 8 is a chart showing example study results for the fluid separation system in accordance with various embodiments. And

FIG. 9 is a chart showing example study results for the fluid separation system in accordance with various embodiments.

### DETAILED DESCRIPTION

Various exemplary embodiments will be described more fully hereinafter with reference to the accompanying drawings, in which some example embodiments are shown. The present disclosure may, however, be embodied in many different forms and should not be construed as limited to the example embodiments set forth herein. Rather, these example embodiments are provided so that this disclosure will be thorough and complete, and will fully convey the scope of the present disclosure to those skilled in the art. In the drawings, the sizes and relative sizes of layers and regions may be exaggerated for clarity. Like numerals refer to like elements throughout.

Unless otherwise defined, all terms, including technical and scientific terms, used herein have the same meaning as commonly understood by one of ordinary skill in the art to which this disclosure belongs. For example, when an element is referred to as being “operatively engaged” with another element, the two elements are engaged in a manner that allows fluid communication from one to the other. A “filtrate” or “permeate” refers to the portion of a feed flow that passes through or across a filter (e.g., a membrane) and thus does not include the particulates, contaminants, and/or other materials removed by the filter. The filtrate, in some embodiments, can be a product of interest, secondary product, or unwanted waste. Conversely, a “concentrate” or “retentate” refers to the portion of the feed flow that includes the particulates, contaminants, and/or other materials remaining in the flow or removed by the membranes during the filtration process. The concentrate, in some embodiments, can be, for example, a product of interest, secondary product, or unwanted waste. It will be further understood that terms, such as those defined in commonly used dictionaries, should be interpreted as having a meaning that is consistent with their meaning in the context of the relevant art and will not be interpreted in an idealized or overly formal sense unless expressly so defined herein. The filtrate and the concentrate can be the results of a separation process provided by passing the fluid through or across a filtering fluid membrane in which the filtrate or permeate is fluid or material that is small enough to pass through pores within a membrane and the filtrate or retentate is fluid or materials that cannot enter the pores as they pass through or across the membrane.

Embodiments of the present disclosure generally provide multi-stage fluid separation of a fluid solution to produce a recovered fluid. In some embodiments, the systems of the present disclosure can include a reactor such as an electrocoagulation unit for performing electrochemical molecular separation of the fluid solution, a filtration unit such as a high solids capacity filter for filtering the electrochemically separated fluid solution, and a filtration unit having, for example, a ceramic membrane filter for further filtering the electrochemically separated and filtered fluid solution.

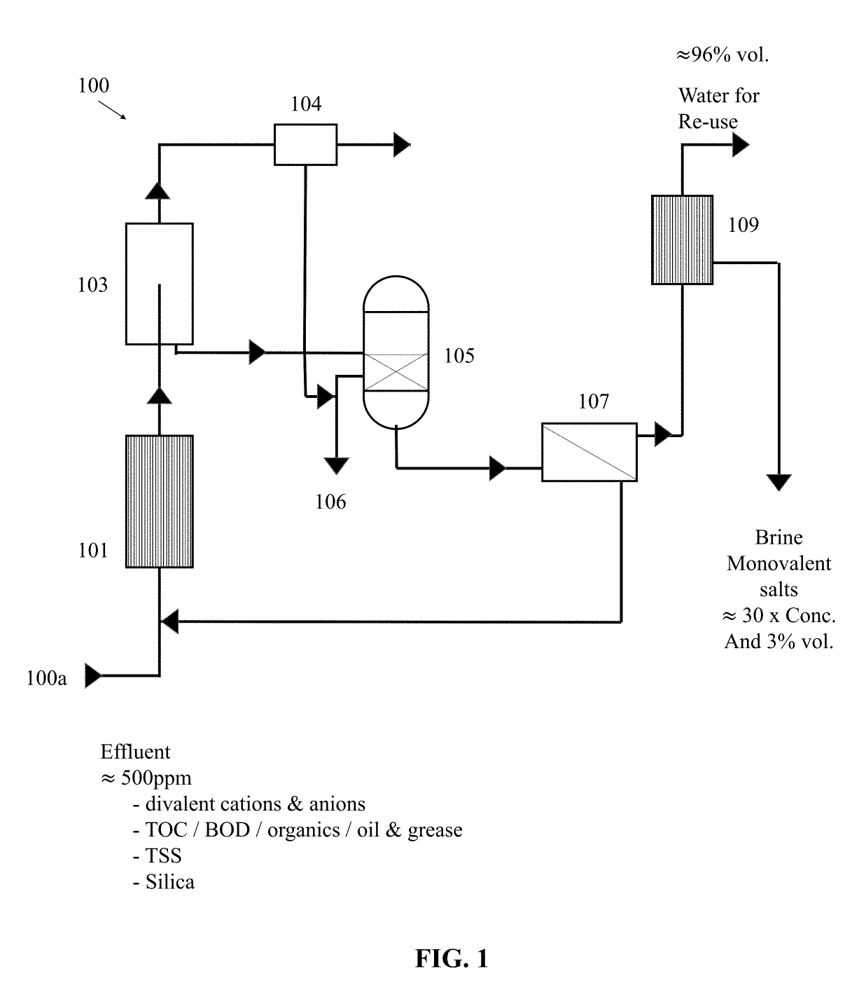

Referring now to FIG. 1, a schematic diagram of a fluid separation system 100 is provided. The fluid separation system 100, in some embodiments, includes an inlet 100a configured to direct a feed flow of fluid solution into the fluid separation system 100. In some embodiments, the feed flow of fluid solution can include any fluid, such as, for example, effluent, sewage, industrial waste, petroleum products, environmental runoff, fracking fluid, contaminated water, gray water, any other fluid solution, or combinations thereof. The inlet 100a can be an opening and/or include any suitable device for directing a feed flow, including, for example, a tube, a pipe, a pump, or any other suitable device.

The fluid separation system 100, in an embodiment, can also include a reactor 101 in fluid communication with the inlet 100a for receiving the fluid solution. The reactor 101, in accordance with various embodiments, can be any device or unit capable of performing electrochemical separation of the fluid solution. For example, the reactor 101 can be any device configured to promote coagulation of the materials in solution, for instance, one or more solids suspended in the fluid solution, and/or capable of degassing the fluid solution. In some embodiments, the reactor 101 can be an electrocoagulation unit. The reactor 101, in some embodiments, can apply a direct current to the fluid solution in order to create highly localized shifts in pH. Such localized shifts in pH can create micro-zones whereby the localized pH is either significantly higher, or lower than the pH of the bulk solution.

With respect to coagulating suspended materials within the fluid solution, generation of localized zones of high or low pH can assist with dissolving a portion of one or more sacrificial electrodes. The dissolved sacrificial electrode material can include any suitable material including, for example, iron or aluminum. The dissolved sacrificial electrode material, in some embodiments, can bond with one or more suspended materials within the fluid solution to promote coagulation by flocculation of the suspended materials. The suspended materials, in accordance with various embodiments, can include, for example, total suspended solids (TSS), colloidal silica, organics, precipitated ions, any other suspended solids, or combinations thereof.

To the extent the fluid solution needs to be degassed or degassing is employed, generation of zones within the solution having a particularly high or particularly low pH can advantageously promote degassing of the solution by affecting the solubility of particular gasses within the solution. For example, dissolved carbon dioxide (CO₂) gases are in equilibrium with bicarbonate ions (HCO₃⁻) and ammonia (NH₃) gases are in equilibrium with ammonium ions (NH₄⁺). The ratio of dissolved carbon dioxide to bicarbonate ions as well as the ratio of dissolved ammonia to ammonium ions is pH dependent. In particular, bicarbonate ions are converted to carbon dioxide under localized low pH environments and ammonium ions are converted to ammonia under localized high pH environments. Thus, degassing is achieved by the localized shifts in pH because, as the solubility of each gas decreases, the respective concentration of each gas can exceed the reduced solubility limit, causing the gasses to fall out of solution and form bubbles within the solution. Furthermore, as carbon dioxide is removed from the fluid solution, the overall pH of the solution increases, thus decreasing the solubility of divalent ions.

In some embodiments, the system 100 can also include a degassing chamber 103 downstream of the reactor 101. In some embodiments, the degassing chamber 103 can be positioned proximate and downstream of the reactor 101. In particular, it will be understood that, given sufficient time and pH conditions, the gasses released by the reactor 101 can re-dissolve back into solution. Thus, providing a degassing chamber 103 immediately downstream of the reactor 101 can advantageously physically remove the gasses from the feed solution so as to prevent their reintroduction. However, it will be apparent in view of this disclosure that, in some embodiments, the degassing chamber 103 can be integrated with the reactor 101 and that, in some embodiments, the degassing chamber can be positioned downstream but not proximate to the reactor 101.

The degassing chamber 103, in some embodiments, can be sized to provide sufficient length and height for gasses released by the reactor 101 to separate from the fluid solution and to permit further flocculation of the suspended materials. For example, in some embodiments, the degassing chamber 103 can include a length sized such that, at a nominal downward liquid velocity of 0.001 meter per second, microbubbles having a diameter of less than 1 mm and a nominal upward velocity of 0.004 meters per second are permitted to rise and be removed from the top of the chamber 103 as foam and the fluid solution and suspended materials can exit the bottom of the chamber 103. The height of the chamber 103 can be sized to enable efficient separation of the gas and foam while permitting sufficient residence time prior to discharge to permit flocculation. The volume of gas removed by the chamber 103 depends, in part, upon the amount of dissolved gases and bicarbonate (HCO₃) ions present in the fluid solution. For example, in some embodiments, volumetric flow of gas can be about 10% to about 15% of an incoming volumetric flow of the solution. The chamber 103 can also be sized to permit sufficient residence time for the suspended materials contained with liquid to accumulate as floc. For example, the residence time for flocculation can be between about 5 to about 30 minutes. As discussed above, in some embodiments, the floc formation can be facilitated by the presence of the sacrificial metal added by the sacrificial electrodes of the reactor 101.

In accordance with various embodiments, the foam exiting the top of the degassing chamber 103 with the separated gas can include, for example, volatile and non-volatile organics, ammonia, fats, grease, other contaminants, and combinations thereof. In some embodiments, such contaminants can be further separated and further processed in a defoaming unit 104. In accordance with various embodiments, the defoaming unit 104 can apply heat and/or ultrasonic energy to the foam to reduce a volume of the foam by separating the contaminants from the gas.

Once the contaminants are substantially separated from the gas by the defoaming unit 104, the contaminants or retentate can be directed to a recovered solids capture 106. The recovered solids capture 106, in some embodiments, can include one or more of a drain, a container, a reservoir, a pipe, a tube, or any other suitable device or structure for removing, transporting, treating, and/or storing solid, semi-solid, or fluidic waste, or combinations thereof.

The floc and other suspended materials exiting the degassing chamber 103, in some embodiments, can be at least partially removed by a filtration unit 105 downstream of the reactor 101 and the degassing chamber 103. In some embodiments, the filtration unit 105 can be configured to remove contaminants having a size of about one (1) micron or larger. In some embodiments, the filtration unit 105 can include one or more filters. For example, in some embodiments, the filtration unit 105 can include a high efficiency, high solids capacity media filter (HECF). From time to time, it may be necessary to remove solids captured within the filter to renew or reuse the capacity of the filter. To that extent, periodic backwashing may be employed to purge solids captured or removed from the solution by the filter. In order to minimize disruption to the operation of the fluid separation system 100, in some embodiments, the filtration unit can include two or more parallel filters configured to operate in alternating arrangement such that the filters alternate being on-line (actively filtering fluid solution) and off-line (being purged and/or not filtering fluid solution) to enable continuous production. In some embodiments, the filtration unit 105 can be configured to use no more than 1% or less of the feed flow volume to purge solids from the filter(s) such that the filtration unit 105 provides 99% recovery of the feed flow volume as filtered fluid solution. In some embodiments, the floc and other suspended materials removed by the filtration unit 105 can be removed into the recovered solids capture 106.

As shown in FIG. 1, in some embodiments, the system 100 can also include a filtration unit 107 downstream of the filtration unit 105 for more finely filtering the filtered fluid solution. In some embodiments, the filtration unit 107 can be an elongated cartridge structure having one or more filter channels extending therethrough. In some embodiments, the cartridge structure can include one (1) channel, seven (7) channels, nineteen (19) channels, thirty-seven (37) channels, sixty-one (61) channels, eight-five (85) channels, or any other number of channels depending on the application and needs. In some embodiments each channel of the filtration unit 107 can be about 10 centimeters (cm) to about 1.5 meters (m) in length. However, it will be apparent in view of this disclosure that, in accordance with various embodiments, any channel length can be used. In some embodiments, each channel of the filtration unit 107 can have an inner diameter of about three (3) millimeters (mm) to about six (6) mm. However, it will be apparent in view of this disclosure that, in accordance with various embodiments, any channel diameter can be used.

In some embodiments, providing multiple channels within the cartridge, rather than a single, larger channel, can increase total membrane surface area while decreasing the size of cartridge. In accordance with various embodiments, the filtration unit 107 can be constructed of any material having suitable porosity, pore size, and chemical resistance for permitting passage of filtrate therethrough. For example, in some embodiments, the filtration unit 107 can be constructed of aluminum oxide ceramic membranes, available from Atech Innovations gmbh, Type 19/33, having 19 channels of 3.3 mm in diameter and 1000 mm to 1500 mm length. Other ceramic membrane cartridges from Atech (e.g., having different number of channels such as 1, 7, 37, 61, 85, etc., or different diameters, and/or different lengths) or other vendors can also be used.

In some embodiments, the filtration unit 107 cartridge structure itself can provide filtration. In some embodiments, the filtration can be provided by one or more membranes positioned on an inner or outer surface of the filter channels of the cartridge. The membranes can be constructed of any suitable material such as a porous ceramic or polymer and can generally include smaller pores than the filtration unit 107 cartridge material for filtering of smaller contaminants of the fluid solution. In some embodiments, the membranes can be ceramic filters wherein pores in the membrane can be produced using DNA template according to the molecular separation systems and methods described in U.S. Pat. Nos. 8,431,508, 8,431,509, and 8,426,333, the disclosure of which are incorporated herein in its entirety by reference. By templating membranes with DNA, the pore size distribution can be narrower, smaller, and can correlate to better size selectivity for neutral molecules above and below the pore size (as well as for charged ions).

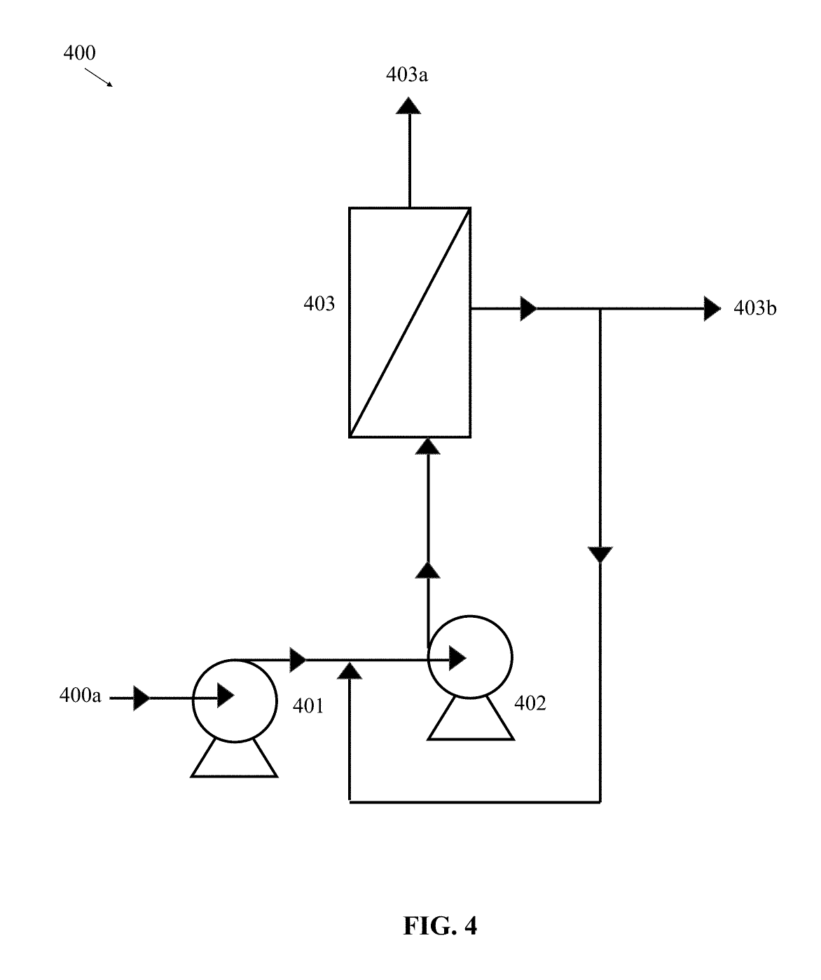

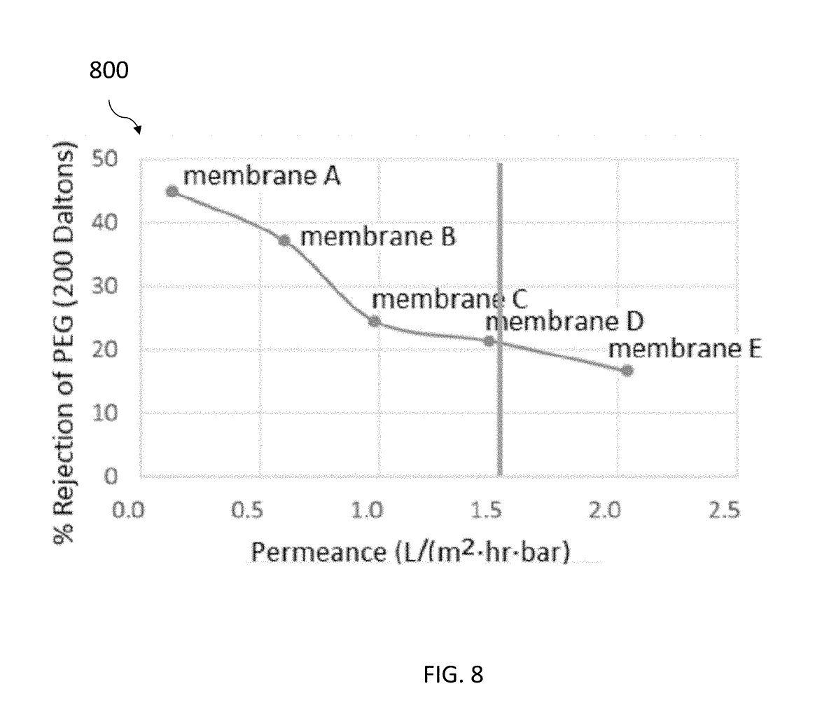

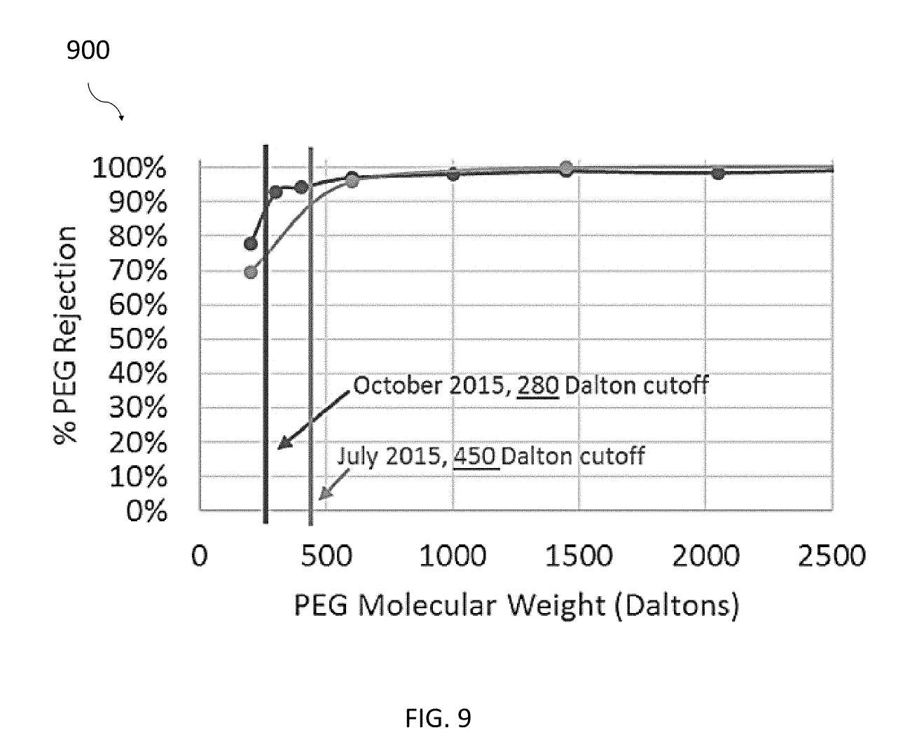

Additionally, the shape of the DNA molecule can produce pores through the membrane that contribute to relatively faster filtration. Filtration speed is related to permeance through the filter or membrane with higher permeance filters or membranes using less energy because they can operate at lower pressures in pushing the fluid through. Some membranes can be relatively dense in their material makeup and can have relatively small spaces within the material that may not be susceptible to irreversible fouling in aqueous filtration because pore clogging may not necessarily occur, and at most only surface fouling can occur. Therefore, the use of a DNA template to generate pores through such a membrane can allow, for example, highly dense membrane materials that do not exhibit bypass to increase its permeance to increase filtration speed. For purposes of this disclosure, bypass occurs when fluid passes through or across the membrane material (e.g., filter). This is in contrast to other ceramic/nanofiltration membranes that use a looser ceramic network as a mechanism for transport or flow through that are susceptible to bypass, which do not provide the advantages of the present disclosure, discussed in greater detail with respect to FIGS. 4-9. As another advantage, in some embodiments, filter properties of the templated DNA membranes can be tuned by controlling different aspects of the DNA used in forming the pores in the membrane layer, as discussed in greater detail with respect to FIGS. 8 and 9.

Once the DNA templated membranes of the present invention are positioned within the channel(s), the resulting membrane coated channel(s) of the filtration unit 107 can be used for filtration processes such as, for example, cross-flow filtration. For example, DNA templated membranes can be coated on or positioned within the one or more channels of a ceramic (e.g., filter unit), resulting in an inside out filtration design. More specifically, applying pressure in a flow (or a transmembrane pressure) through the channel(s) of the filtration unit 107 can create a second flow perpendicular to the bulk volume of the fluid flowing through channel(s) across or through the membranes of the filtration unit 107. The second flow can directed from the bulk volume of fluid in the channel(s) across or through the membranes of the filtration unit 107 to permeate through the DNA templated pores of the membrane, such that during this cross-flow filtration process, in which the bulk fluid flow moves parallel to the membrane filtration surface of the channel(s), molecules larger than the pore size within the membrane can pass along the channels of the cartridge and exit the cartridge as a retentate of the filtration unit 107, while smaller molecules can enter the DNA templated pores and permeate through or across the membrane as part of a filtrate of the fluid solution. In some embodiments, the membranes of the filtration unit 107 can be configured to allow contaminants having a size of about 0.6 nanometers (nm) or larger to remain in the fluid solution (e.g., too large to permeate the DNA sized pores). To the extent that different size contaminants are to be removed, it should be appreciated that the templated pores in the membrane can be made to be larger or smaller, as appropriate. In some embodiments, the filtration unit 107 can be configured to remove suspended materials having a molecular weight of about 400 Daltons (Da) or greater.

By removing such small-scale contaminants, in some embodiments, the filtration unit 107 can act to substantially remove any remaining suspended materials and reduce remaining concentrations of dissolved contaminants as water passes through or across the sub-nanometer DNA sized ceramic pores. Advantageously, in some embodiments, ceramic filtering membranes, unlike conventional polymer based membranes, are able to resist fouling in the presence of elevated levels (e.g., greater than 50 ppb) of dissolved iron and/or aluminum in the fluid solution. Additionally, ceramic filtering membranes are able to withstand oxidation in the presence of chlorine and/or ozone both alone and when combined with multivalent metals that may act as a metal catalyst. As a portion of the filtered fluid solution permeates through or across the membrane of the filtration unit 107, the concentration of contaminants in the retentate increases.

In order to improve overall recovery within the system, at least a portion of the retentate can be recirculated to the reactor 101 for further processing by the fluid separation system 100. Advantageously, because of the increased concentration of dissolved materials in the retentate as compared to the filtered fluid solution received from the filtration unit 105, the reactor 101, in some embodiments, can cause at least a portion of the dissolved materials to precipitate out of the retentate, thereby avoiding saturation of the fluid solution, which can otherwise prevent the filtration unit 107 from operating efficiently.

Although the retentate is shown and described herein as being recirculated through the reactor 101 for further processing by the fluid separation system 100, it will be apparent in view of this disclosure that, in accordance with various embodiments, the retentate can instead simply be disposed of. It will further be apparent in view of this disclosure that, in some embodiments, the retentate can be directed to one or more other components of the system 100 and/or to other equipment or systems.

The filtrate, in some embodiments, can exit the filtration unit 107 and be passed downstream within the system 100. Still referring to FIG. 1, in some embodiments the system 100 can also include a desalination unit 109 downstream of the filtration unit 107 for receiving the filtrate. The desalination unit 109, in some embodiments, can provide removal of trace amounts of divalent cations and anions as well as a bulk of monovalent salts from the filtrate received from the filtration unit 107. In some embodiments, by removing the divalent cations, divalent anions, and monovalent salts, the desalination unit 109 can, for example thus advantageously prevent accumulation of the monovalent salts within the fluid separation system or at locations where the recovered fluid is ultimately used.

In some embodiments, the desalination unit 109 can output a brine waste and recovered fluid for subsequent re-use. In some embodiments, the brine waste can include a concentration of monovalent salts at least about 30 times higher than the concentration of monovalent salts in the filtrate received from the filtration unit 107. In some embodiments, the desalination unit 109 can be configured to use no more than 3% or less of the initial feed flow volume to remove brine waste, including the divalent cations, divalent anions, and monovalent salts, from the desalination unit 109. Thus, accounting for the 1% fluid loss associated with the filtration unit 105, the filter system 100 provides a volume of recovered fluid of at least about 96% of a volume of the feed flow.

In some embodiments, a supplemental gas stream can be added upstream of the reactor 101 and/or degassing chamber 103. The supplemental gas can be comprised of air or air treated for reduced levels of CO₂. Excess gas added prior to the degassing chamber can be removed through the defoamer 104. In some embodiments, the supplemental gas flow rate range can be between 10% and 200% of the volumetric flow of the feed flow fluid solution. In some embodiments, supplemental gas can advantageously assist in stripping dissolved gases (like CO₂ and NH₃) contained in the feed stream and assist in removing TOC, BOD, COD, oil and grease, or other contaminants contained in feed stream through entraining these contaminants within the foam that is discharged through the defoaming unit 104.

In some embodiments, a chemical oxidizer (e.g., sodium hypochlorite or ozone gas that is dissolved) can be introduced downstream of the degassing unit 103. Excess gas can be removed through the defoaming unit. The chemical oxidizer can be added at a rate between 10% and 100% above the stochiometric requirement for the targeted application. Addition of the oxidizer can advantageously assist in maintaining microbial control within the process equipment and process solution, assist in reducing TOC, BOD, COD, oil and grease, or other contaminants contained in feed stream through the oxidation of these contaminants, quickly oxidize dissolve multivalent metals such as iron to form insoluble iron oxide which may be removed through flocculation in the degassing unit 103 and subsequent filtration at filtration unit 105, and convert ammonia into nitrite and nitrates through nitrification.

In some embodiments, a chemical oxidizer (e.g., sodium hypochlorite or ozone gas that is dissolved) can be introduced downstream of the filtration unit and upstream of the filtration unit 107. Excess gas can be removed through the defoaming unit. The chemical oxidizer can be added at a rate between 10% and 100% above the stochiometric requirement for the targeted application. Addition of the oxidizer can advantageously assist in maintaining microbial control within the process equipment and process solution, assist in reducing TOC, BOD, COD, oil and grease, or other contaminants contained in feed stream through the oxidation of these contaminants, convert ammonia into nitrite and nitrates through nitrification, and aid in the rapid cleaning and sanitizing of the ceramic filtering membrane.

In some embodiments, as a means of destructing ammonia, the ammonia gas separated from the process liquid and removed from the process as gas at the defoaming unit 104 can be directed into a downstream flare gas stream prior to ignition of the flare gas stream.

In some embodiments, the fluid separation system 100 can include a vacuum pump downstream of the degassing unit 103 and upstream of the defoaming unit 104 to permit the degassing unit to operate at full or partial vacuum.

Thus, the fluid separation system 100 described herein, by use of reactors such as electrocoagulation (EC) units and high capacity/high efficiency media (HECF) filtration with ceramic filtering, can advantageously remove contaminants such as Total Suspended Solids (TSS), divalent cations and anions, Total Organic Carbon (TOC), Chemical Oxygen Demand (COD), Biological Oxygen Demand (BOD), heavy metals, organics, silica, oil, grease, microbes, and viruses under high hydraulic recovery conditions in a continuous process. Further advantageously, by the addition of a desalination unit after the filtration unit, the fluid separation system 100 can further provide for removal of trace divalent cations and anions as well as monovalent cations and anions in addition to the above contaminants.

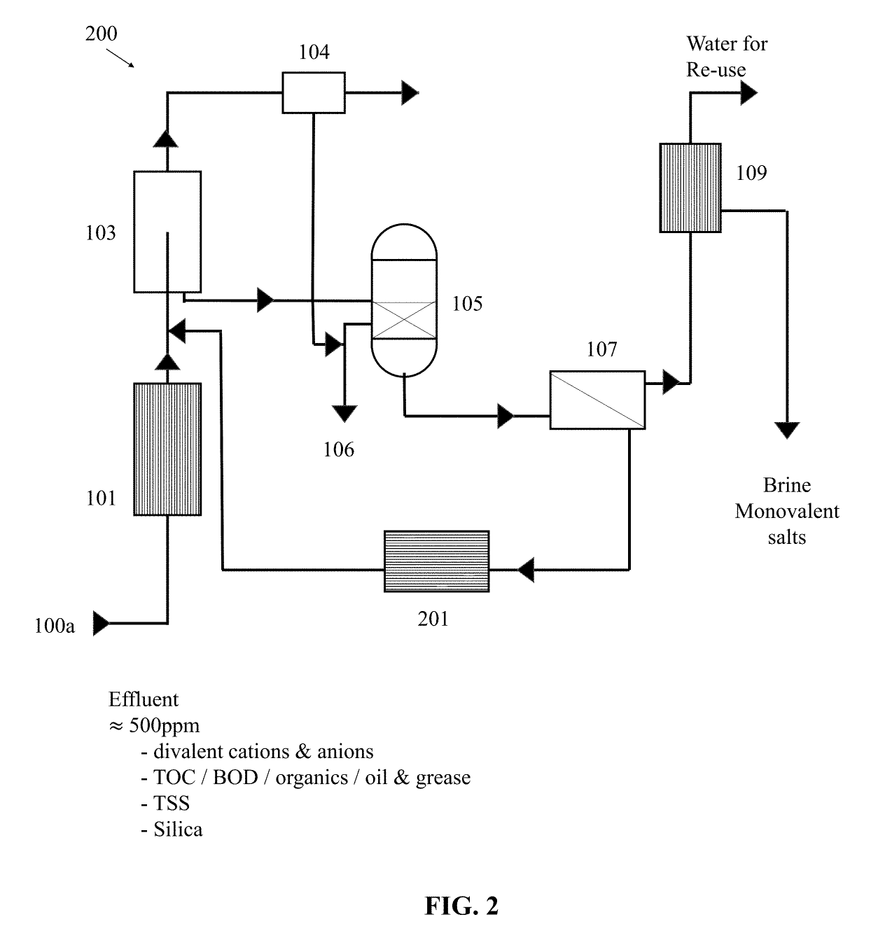

Referring now to FIG. 2, in some embodiments, a fluid separation system 200 can include one or more of a reactor 101, a degassing unit 103, a defoaming unit 104, a filtration unit 105, a recovered solids capture 106, a filtration unit 107, and a desalination unit 109 as described above with reference to FIG. 1. The fluid separation system 200 of FIG. 2 can also include a second reactor 201 in downstream fluid communication with the filtration unit 107 for receiving the retentate. The second reactor 201 can be, for example, but not limited to, reactor 101 described herein above with reference to FIG. 1. In some embodiments, the addition of the second reactor 201 permits adjustment of one or more operating conditions of the second reactor 201 to more efficiently treat a chemistry of the retentate. As shown in FIG. 2, the retentate treated by the second reactor 201 can then be recirculated into the fluid separation system 200 at the degassing unit 103 for further processing.

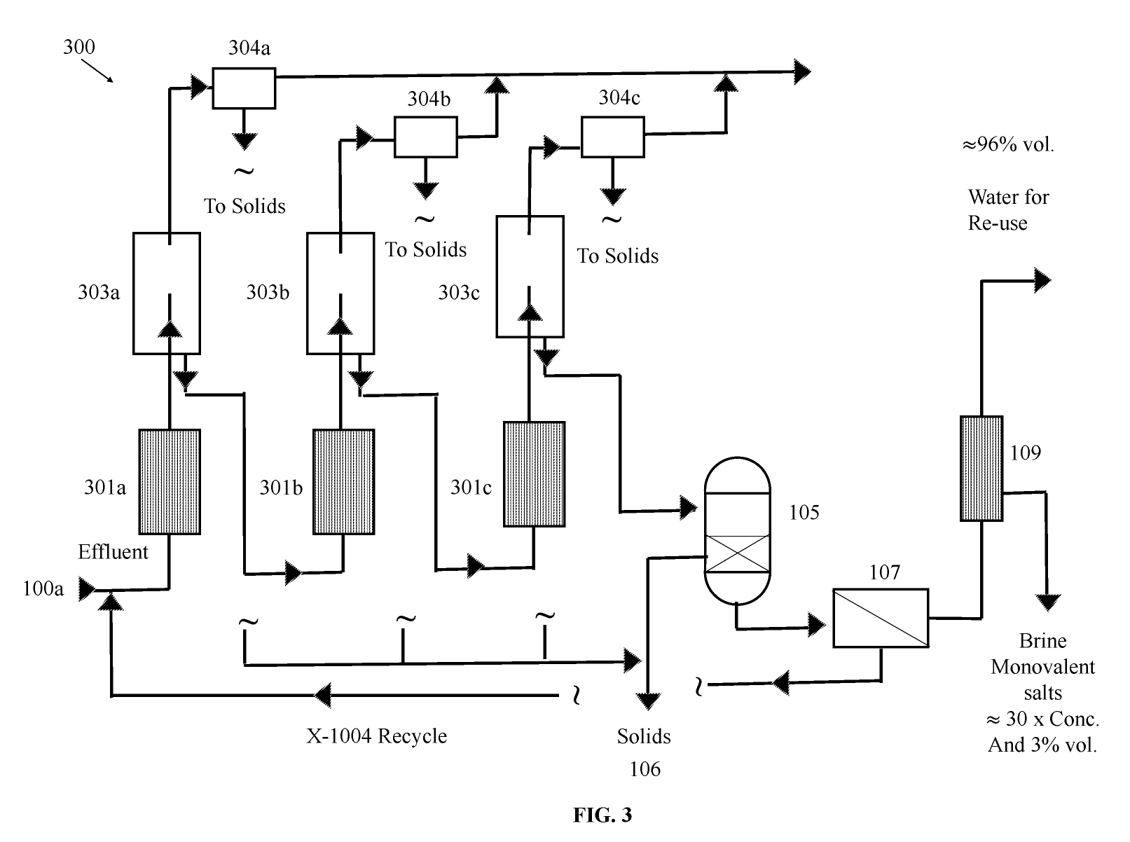

Referring now to FIG. 3, in some embodiments, a fluid separation system 300 can include one or more of a filtration unit 105, a recovered solids capture 106, a filtration unit 107, and a desalination unit 109 as described above with reference to FIG. 1. The fluid separation system 300 of FIG. 3 can also include first, second, and third reactors 301a, 301b, and 301c aligned in series for providing additional degassing of the feed flow of fluid solution and further flocculation of suspended materials within the fluid solution. In some embodiments, each of the first, second, and third reactors 301a, 301b, and 301c can be, for example substantially similar to reactor 101 as described above with reference to FIG. 1. In some embodiments, one or more of the first, second, and third reactors 301a, 301b, and 301c can include a permanent electrode, rather than a sacrificial electrode. Although permanent electrodes do not promote flocculation as well as sacrificial electrodes, the cost of maintenance is lower because the electrodes do not need to be replaced as often, if at all. Therefore, in order to provide improved degassing of the fluid solution, in some embodiments, for example, the first and second reactors 301a, 301b can include permanent electrodes for providing substantial degassing and the third reactor 301c can include sacrificial electrodes for providing improved flocculation. However, it will be apparent that in view of this disclosure that any number of the first, second, and third reactors 301a, 301b, and 301c can include sacrificial or permanent electrodes (e.g., all three having permanent electrodes, all three having sacrificial electrodes, one having a permanent electrode and two having sacrificial electrodes). Furthermore, it will be apparent in view of this disclosure that the sacrificial and permanent electrodes can be distributed amongst the first, second, and third reactors 301a, 301b, and 301c in any order. That is, where only one reactor 301a, 301b, 301c includes sacrificial electrodes, the sacrificial electrodes can be provided in any of the first, second, and third reactors 301a, 301b, and 301c depending on the amount of flocculation time desired. Furthermore, it will be apparent in view of this disclosure that additional or fewer reactors can be used in accordance with various embodiments.

Still referring to FIG. 3, in some embodiments, each of the first, second, and third reactors 301a, 301b, and 301c can be paired, respectively, with a first, second, or third degassing chamber 303a, 303b, 303c. In some embodiments, each of the first, second, or third degassing chambers 303a, 303b, 303c can be, for example, substantially similar to the degassing chamber 103 discussed above with reference to FIG. 1. Advantageously, by providing first, second, and third reactor-degassing chamber pairs 301a-303a, 301b-303b, and 301c-303c, each connected in series, the gas and other foam contaminants (e.g., volatile and non-volatile organics, ammonia, fats, grease, other contaminants, and combinations thereof as described above) released by each reactor 301a, 301b, and 301c can be removed from the fluid solution by the paired degassing chamber 303a, 303b, 303c prior to being re-dissolved into the solution. However, it will be apparent in view of this disclosure that additional or fewer degassing chambers can be used in accordance with various embodiments to each receive treated fluid solution from one or more reactors in any suitable order.

In some embodiments, the system 300 can also include one or more defoaming units 304a, 304b, 304c. As shown in FIG. 3, first, second, and third defoaming units 304a, 304b, 304c are provided downstream, respectively of each of the first, second, and third degassing chambers 303a, 303b, 303c for separating the removed gas from the removed contaminants in the foam. In some embodiments, each of the first, second, and third defoaming units 304a, 304b, 304c can be, for example, substantially similar to the defoaming unit 104 discussed above with reference to FIG. 1. Furthermore, it will be apparent in view of this disclosure that additional or fewer defoaming units can be used in accordance with various embodiments to receive removed foam from one or more degassing units in any suitable order.

Advantageously, the system 300 of FIG. 3 promotes more complete degassing of the fluid solution, thereby reducing respective concentrations of dissolved gasses and related ions contained within the fluid solution. Thus, higher percentages of carbon dioxide and ammonia gas can be removed from the feed solution more efficiently and economically than if a single set of reactors, degassing unit, and defoaming unit operated alone. Further, removal of carbon dioxide and bicarbonate promotes the formation hydroxide (OH⁻) complexes that are less soluble than their bicarbonate equivalents. Thus, downstream reactors 301b, 301c can be more efficient in removing heavy metals and other multivalent cations.

In some embodiments, the fluid solution can be directly introduced into an array of filtering units 403 independent of any electrochemical separation, application of heat and/or ultrasonic energy, or any other type of filtration/pretreatment provided in systems 100, 200, 300. Referring to FIG. 4, there is shown an exemplary example of a system 400 in which the fluid solution is introduced to the array of filtering units 403 without the pretreatment/filtration performed in FIGS. 1-3. Based on the system 400 provided in FIG. 4 can be ideal for applications (among other applications) in which the fluid does not contain a substantial amount of suspended solids, and thus can provide economic savings from a reduced treatment train.

In some embodiments, as illustrated in FIG. 4, a schematic diagram of a two-pump system 400 is provided. The two-pump filtering system 400 can include a feed pump 401, a recirculating pump 402, and an array of filtering units 403 (or single filtering unit), as described above with reference to FIG. 1. The system 400 includes an inlet 400a configured to direct a feed flow of a fluid solution into the high-pressure feed pump 401. In some embodiments, the feed pump 401 can be capable of operating at 200 to 1000 psi pressure for delivering flow of 5 to 20 Gallons per minute (GPM) (e.g., a first pressure), or higher, depending on the array of filtering units 403. The system 400 can be configured to deliver the flow the fluid solution from the feed pump 401 to the recirculating pump 402. In some embodiments, the recirculating pump 402 can be a high flow rate and low-pressure pump that is capable of receiving the range of pressure from feed pump 401 and operates at 20 to 200 psi pressure for delivering flow of 20 to 300 GPM (e.g., a second pressure), or higher, depending on the array of filtering units 403. In operation, the second pump can be utilized to increase the flow rate received from the first pump to provide an optimum cross flow velocity through the channels of each membrane in the filtering units 403. In some embodiments, the feed pump 401 and the recirculating pump 402 can be a single pump configured to provide both a high flow rate as well as operate at a higher pressure.

The system 400 can be configured to deliver the flow from recirculating pump 402 into the filtering units 403. The flow from recirculating pump 402 can be provided with a high enough fluid flow rate to provide turbulent flow with Reynold's number >6000 for a 2 m/s cross flow velocity in each channel of the filtering units 403. In some embodiments, each filtering unit 403 can contain multiple DNA templated membranes. The DNA templated membranes are configured to separate contaminants from fluid at a higher pressure than conventional ceramic membranes because the conventional ceramic membranes lack the ability to provide permeance through pores at elevated pressures because the bulk of the fluid will bypass the pores. The array of filtering units 403 can be designed in a parallel array or in series. Alternatively, the system 400 can use a single filtering unit 403 instead of an array. After passing through or across the filtering units 403, the filtrate 403a from the fluid solution can be passed downstream from the system 400 for disposal. In some embodiments, the retentate 403b can be recirculated upstream of the recirculating pump 402 for further processing and filtering in the system 400, to one of the other systems 100, 200, 300, or output for use. In some embodiments, a small stream, if not all of the retentate 403b, can also be disposed of. For example, the retentate 403b can be disposed of if the application is note dependent on a high recovery or if there is no value in saving the retentate.

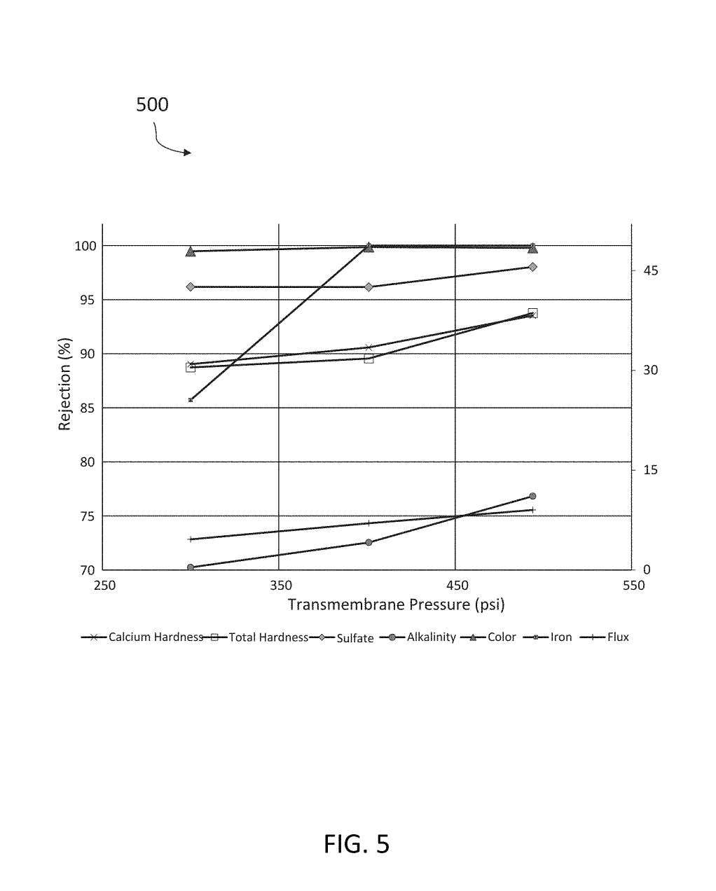

FIGS. 5-9 depict example data illustrating the benefits provided by the systems discussed with respect to FIGS. 1-4 over conventional ceramic systems. The data provided in FIGS. 5-9 are merely for illustrative purposes and are not intended to limit the scope of the present invention.

Referring now to FIG. 5, a chart 500 is depicted showing the advantages of the systems discussed herein. The chart 500 has an x-axis reflecting the transmembrane pressure, in psi, for a filtering unit and a y-axis reflecting a rejection percentage of dissolved contaminants in the fluid solution provided by the filtering unit. The values included within the chart 500 include calcium hardness, total hardness, sulfate, alkalinity, color, iron, and flux. As shown in FIG. 5, with a mixture of dissolved contaminants, the DNA membrane of the filtering unit is able to result in increased rejection of said contaminants with increasing transmembrane pressure. This result can be attributed to the small pore size and narrow pore size distribution the prevents bypass of the feed product through the pores and underlying support structure resulting from DNA templating.

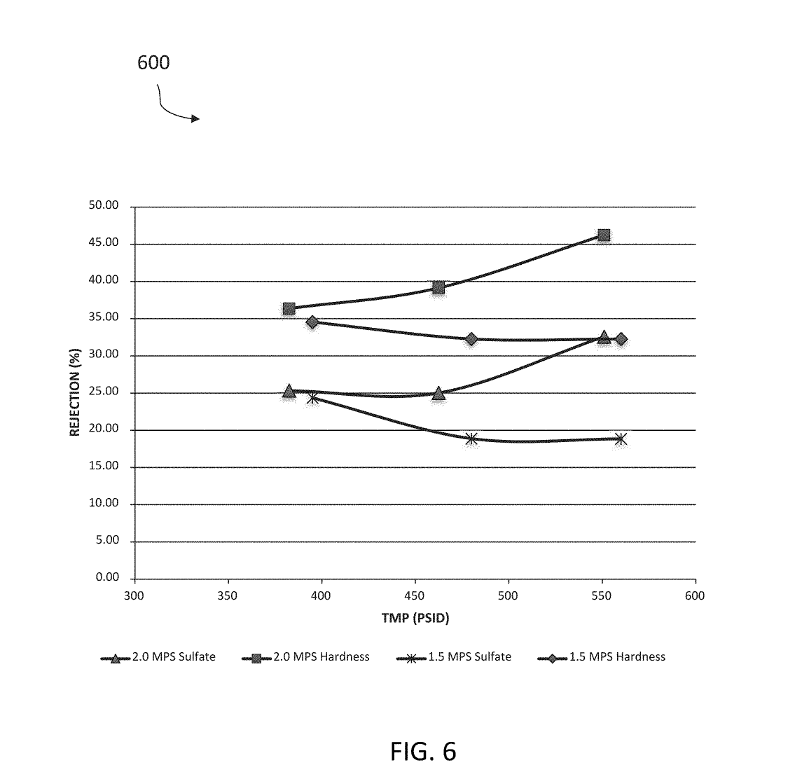

Referring now to FIG. 6, a chart 600 is depicted showing the advantages of the systems discussed herein. The chart 600 has an x-axis reflecting the transmembrane pressure, in psi, for a filtering unit and a y-axis reflecting a rejection percentage of dissolved contaminants in the fluid solution provided by the filtering unit. The values included within the chart 600 include 2.0 MPS sulfate hardness, 2.0 MPS hardness, 1.5 MPS sulfate hardness, and 1.5 MPS hardness for a 35,000-ppm mixed salt solution. As shown in FIG. 6, shows that increasing the cross-flow velocity results in increased rejection of dissolve solids. This increase can be attributed to the turbulent flow (Reynolds number >6000) at 2 m/s cross-flow velocity that allows for optimum gel layer formation at the surface of the membrane of the filtering unit, which can contribute to rejection of various dissolve solids such as sulfate and hardness. This gel layer can enhance rejection even at high salt concentrations where the Debye length is shorter than the pore size diameter because of the high transmembrane pressures that optimize gel formation and rejection of dissolved solids.

### EXAMPLES

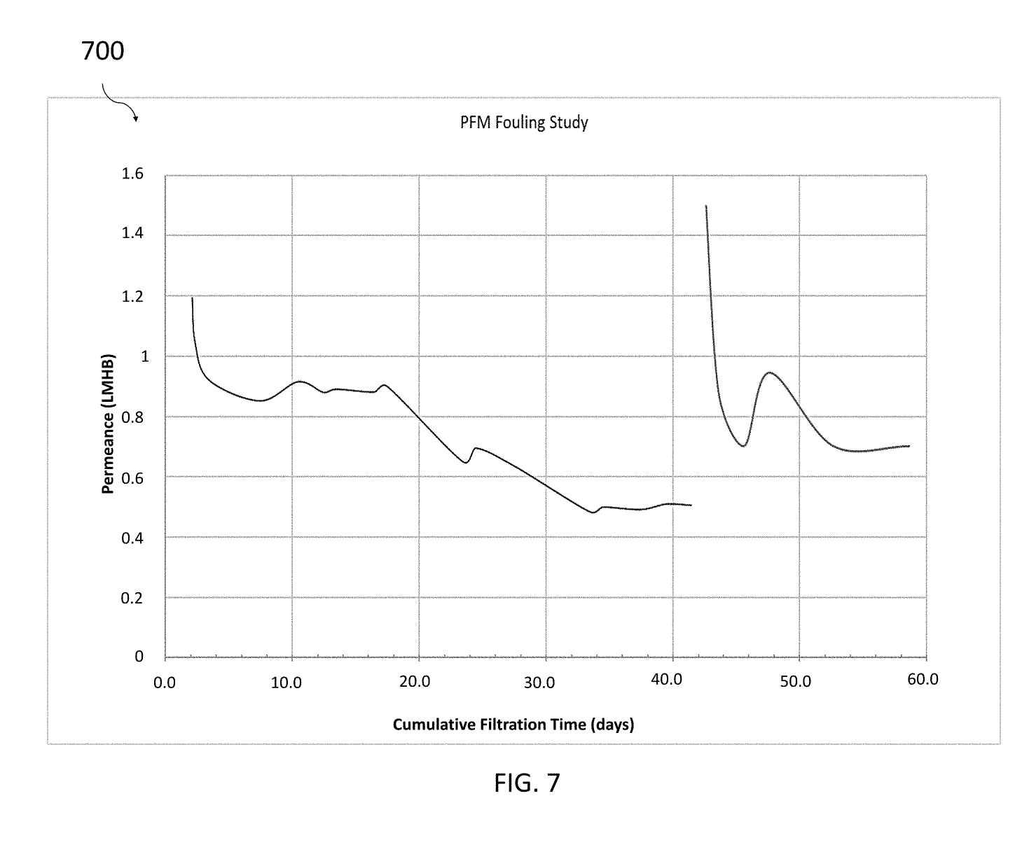

In a three-month fouling study, the membrane of the filtering unit was run at specific conditions to increase fouling propensity (laminar flow, high dispersed oil feed) for forty consecutive days. Afterwards, the membrane of the filtering unit surface was chemically treated in a clean-in-place procedure where the flux recovered >90% of the steady state flux. This increased fouling-resistant feature is attributed to the glass-like surface of the DNA template active layer, in which the pores are so small they prevent clogging from contaminants. Referring now to FIG. 7, a chart 700 is depicted showing the results of the study. The chart 700 has an x-axis reflecting cumulative filtration and a y-axis reflecting permeance of the filtering unit. The lines in FIG. 7 show how operational permeance decreases over continuous filtration time and how, after a certain time has passed, a clean-in-place procedure is conducted to determine flux (permeance) recovery.

Referring to FIG. 8, FIG. 8 depicts a graph 800 that shows how the percentage of DNA concentration in the DNA template can control the tradeoff between permeance and selectivity in the resulting membrane. By varying the size and/or concentration of the DNA template, the filter properties can be optimized for either higher purity (better rejection of small contaminants) or higher permeance through the pores in the membrane (lower energy process). For example, the pore size and/or concentration can be smaller and less dense for a higher purity process, or alternatively, the pore size and/or concentration can be larger and more dense to have a lower energy process. In accordance with an embodiment of the present invention, the target permeance for some commercial applications can be >1.5 1-m2-h/bar. Continuing with FIG. 8, the graph 800 has a y-axis that shows the percentage of polyethylene gycol (PEG) rejection from a solution and an x-axis that shows the level of permeance. The graph 800 is a result of a study of membranes made with a range of DNA percentage of ‘A’ with the highest DNA concentration percentage to ‘E’ with the lowest DNA concentration percentage (e.g., used within one of the systems 100-400). With little or no DNA, pores are larger: this is shown by molecules passing more easily through as well as a faster permeance. For example, with ‘A’ using DNA-templated pores, the large pores are eliminated, small molecules are removed more efficiently, and the smaller pores result in slower permeance.

Referring to FIG. 9, FIG. 9 depicts a graph 900 that shows improved membrane retention below 300 Daltons for the DNA formed membranes. The graph 900 has a y-axis that shows the percentage of polyethylene gycol (PEG) rejection from a solution and an x-axis that shows the PEG molecular weight. The graph 900 is a result of a study with an 100% removal of polyethylene glycol molecules larger than 1500 Daltons (grams/mole) when using the DNA template membranes (e.g., within one of the systems 100-400). The DNA formed membrane filters, at the molecular level, removes contaminants based on their size (anything larger than the filter pore) as well as by charge. By using a standard method (Afnor NF-X 45-103) the rejection due to size alone can be measured. The results are reported as molecular weight cutoff where the cutoff value is the size above which 90% rejection occurs. The lower the cutoff value, the greater the membrane retention is for small molecule contaminants.

While the present disclosure has been described with reference to certain embodiments thereof, it should be understood by those skilled in the art that various changes may be made and equivalents may be substituted without departing from the true spirit and scope of the disclosure. In addition, many modifications may be made to adapt to a particular situation, indication, material and composition of matter, process step or steps, without departing from the spirit and scope of the present disclosure. All such modifications are intended to be within the scope of the claims appended hereto.

What is claimed is:

1. A fluid separation system comprising:
a pressurized feed pump for introducing a fluid solution at a first predetermined pressure;
a recirculating pump for recirculating the fluid solution from the high-pressure feed pump downstream at a second predetermined pressure; and
a filtering unit downstream of the recirculating pump for receiving the fluid solution at the second predetermined pressure, the filtering unit having a membrane provided with an array of pores approximately a diameter of a DNA strand to remove at least a portion of dissolved solids in the fluid solution passing across the membrane.

2. The system of claim 1, wherein the filtering unit includes the membrane in one or more channels, each of which includes the membrane having the array of pores approximately the diameter of the DNA strand.

3. The system of claim 1, wherein the second predetermined pressure provides a high cross flow velocity and high transmembrane pressures across the membrane of the filtering unit that optimizes gel formation and rejection of dissolved solids.

4. A method for fluid separation comprising:
introducing a fluid solution at a first predetermined pressure, by a pressurized feed pump, to a recirculating pump;
recirculating the fluid solution at a second predetermined pressure, by the recirculating pump, to a filtering unit having a membrane provided with an array of pores approximately a diameter of a DNA strand;
directing the fluid solution through the filtration unit parallel to the membrane at the second predetermined pressure to create a cross-flow filtration process to remove at least a portion of dissolved solids in the fluid solution; and
outputting filtrate for disposal and a retentate for further use.

5. The method of claim 4, further comprising recirculating the retentate to the recirculating pump for repeated filtering.

6. A fluid separation system comprising:
a reactor for coagulating one or more suspended materials in a fluid solution;
a first filtration unit downstream of the reactor for removing a first portion of the coagulated materials; and
a second filtration unit downstream of the filtration unit for removing at least one of a second portion of the coagulated materials or an uncoagulated portion of the suspended materials.

7. The fluid separation system of claim 6, wherein the fluid includes one or more dissolved gasses, wherein the reactor at least partially de-gasses the solution.

8. The fluid separation system of claim 6, wherein the reactor further comprises an electrocoagulation unit capable of applying a direct current to the fluid solution.

9. The fluid separation system of claim 6, wherein the first filtration unit includes a high efficiency/high solids capacity media filter (HECF).

10. The fluid separation system of claim 6, wherein the second filtration unit includes a ceramic membrane filter.

11. The fluid separation system of claim 7, further comprising a de-gassing chamber downstream of the reactor and upstream of the first filtration unit for permitting the gasses released from the de-gassed fluid solution to separate from the fluid solution and for permitting further coagulation of the suspended fluids.

12. The fluid separation system of claim 11, further comprising a de-foaming unit for removing one or more of a volatile compound, a non-volatile compound, a fat, a grease, or an ammonia from the de-gassed fluid solution.

13. The fluid separation system of claim 6, further comprising an electro-desalinization device downstream of the second filtration unit for removing one or more of a divalent cation, a divalent anion, or a mono-valent salt from the fluid solution.

14. The fluid separation system of claim 6, further comprising a second reactor upstream of the reactor for at least partially degassing the solution.

15. The fluid separation system of claim 14, wherein:
the second reactor is an electrocoagulation unit having a permanent electrode; and
the reactor is an electrocoagulation unit having a sacrificial electrode to promote coagulation.

16. The fluid separation system of claim 14, further comprising a second reactor downstream of the second filtration unit for coagulating one or more additional suspended materials in the fluid solution.

17. A method for fluid separation comprising:
coagulating, by a reactor, one or more suspended materials in a fluid solution;
flowing the fluid solution through a first filtration unit downstream of the reactor to remove a first portion of the coagulated materials; and
directing the fluid solution through or across a second filtration unit downstream of the first filtration unit to remove at least one of a second portion of the coagulated materials or an uncoagulated portion of the suspended materials.

18. The method of claim 17, further comprising at least partially de-gassing, by the reactor, the fluid solution.

19. The method of claim 17, wherein the reactor includes an electrocoagulation unit, the step of coagulating further comprising applying a direct current to the fluid solution.

20. The method of claim 18, further comprising:
separating, in a degassing chamber downstream of the reactor, the gasses released from the de-gassed fluid solution; and
further coagulating, in the degassing chamber, the suspended fluids.

21. The method of claim 20, further comprising removing, by a de-foaming unit downstream of the degassing chamber, one or more of a volatile compound, a non-volatile compound, a fat, a grease, or an ammonia from the de-gassed fluid solution.

22. The method of claim 17, further comprising removing, by an electro-desalinization device downstream of the second filtration unit, one or more of a divalent cation, a divalent anion, or a mono-valent salt from the fluid solution.

23. The method of claim 17, further comprising at least partially degassing the solution using a second reactor upstream of the reactor.

24. The method of claim 17, further comprising coagulating, by a second reactor downstream of the second filtration unit, one or more additional suspended materials in the fluid solution.

25. A fluid separation system comprising:
a first reactor for at least partially degassing a fluid solution including one or more dissolved gasses;
a second reactor for coagulating one or more suspended materials in the fluid solution;
a first filtration unit downstream of the reactor for removing a first portion of the coagulated materials; and
a second filtration unit downstream of the first filtration unit for removing at least one of a second portion of the coagulated materials or an uncoagulated portion of the suspended materials.
